(19) United States
(12) Patent Application Publication
(10) Pub. No.: US 2014/0297552 A1
(43) Pub. Date: Oct. 2, 2014

(54) LOGISTICS DESIGNING DEVICE, METHOD AND PROGRAM

(71) Applicant: Hitachi, Ltd., Tokyo (JP)

(72) Inventors: Junko Hosoda, Tokyo (JP); Atsushi Shimoda, Tokyo (JP)

(73) Assignee: Hitachi, Ltd., Tokyo (JP)

(21) Appl. No.: 14/352,153

(22) PCT Filed: Oct. 4, 2012
(86) PCT No.: PCT/JP2012/075809

§ 371 Date: Apr. 16, 2014

(30) Foreign Application Priority Data
Oct. 20, 2011 (JP) 2011-230340

(51) Int. Cl. G06Q 10/08

(52) U.S. Cl. CPC G06Q 10/08345
USPC 705/335

(57) ABSTRACT

Technology capable of obtaining logistics routes for optimizing total costs including not only costs regarding transportation and others but also tariffs in performing global design for logistics and cost calculation is provided. The present design for logistics device (100) includes a design for logistics portion (10) that performs processes of calculating costs including tariffs for logistics routes among bases using input data for the design for logistics. Based on the input data, the design for logistics portion (10) forms combinations of logistics routes and combinations of agreements, calculates costs including tariff amounts in accordance with agreements for each of the logistics routes and paths to thereby calculate total costs including tariffs for each of the logistics routes.

### TECHNICAL FIELD

The present invention relates to technology of information processing such as design for logistics. It particularly relates to technology of calculating logistics routes and costs.

### BACKGROUND ART

Japanese Patent Application Laid-Open Publication No. 2009-223552 (Patent Document 1) is known as a prior art example related to design for logistics. It is described in Patent Document 1 that it is “to show a novel method of selection and to provide a theoretically optimal solution since when the number of variables related to factors such as a plurality of types of transportation means, numbers of used containers, different deadlines of delivery, transportation costs or inventory holding costs increases, calculation performed by combining these variables for obtaining an optimum solution will need a long time” (see Abstract).

### CITATION LIST

### Patent Document

Patent Document 1: Japanese Patent Application Laid-Open Publication No. 2009-223552

### DISCLOSURE OF THE INVENTION

### Problems to be Solved by the Invention

The above-mentioned Patent Document 1 discloses a structure of design for logistics for achieving minimal costs. However, the costs which are the target of the design for logistics structure of Patent Document 1 are transportation costs and inventory holding costs.

Enterprises that develop their business globally import and export products to and from countries all over the world which involves tariffs (customs, customs duties). While transportation costs account for approximately 5% of their sales in general manufacturing industries, tariffs might account to more than 20%. Accordingly, tariffs cannot be ignored in performing global design for logistics at minimal costs.

However, tariffs are determined by complicated rules based on conditions such as types of goods to be imported, countries passed during transportation of goods and the rate of countries of origin. It was accordingly difficult to perform cost calculations while exactly considering tariffs. The rate of countries of origin is a ratio of a value added in a preliminary prescribed country to the value of the product.

In the prior art, in performing global design for logistics and cost calculation thereof, factors regarding tariffs are not considered but local calculation is performed manually or through information processing while considering transportation costs and inventory holding costs whereupon results are obtained by additionally calculating tariff costs afterwards to the calculated results (to be described later, FIG. 23). Accordingly, calculation for optimizing (minimizing) total costs (full costs) and outputting corresponding logistics routes could not be realized so far.

In view of the above facts, it is a main aim of the present invention to provide a technology with which it is made possible to obtain logistics routes for optimizing total costs including not only transportation costs and inventory holding costs but also factors of tariffs in performing global design for logistics and cost calculation thereof and which contributes to improvements in corporate profits.

### Means for Solving the Problems

Typical embodiments of the present invention are a system (design for logistics device), a method and a program or the like for performing information processing including global design for logistics and cost calculation thereof, and they are characterized in that they have configurations as described below.

The present system comprises a function of performing processes of calculating logistics routes with which the total costs including factors of tariffs are minimized. In the present system, pieces of information related to tariffs and agreements are used as input data for calculating tariff costs related to logistics routes (routes passing bases such as suppliers, factories, warehouses and markets). Such pieces of information are, for example, pieces of information related to agreements (free-trade agreements), articles (products and parts), tariff amounts in accordance with agreements and reference values of specified values such as rate of countries of origins related to definitions for calculating tariffs. In various agreements (note that there may be more than one depending on countries or regions), the tariffs are determined based on conditions such as types of goods to be imported, countries or regions that have been passed during transportation of goods and rate of countries of origins.

The present system includes: (1) a first processing portion to which second pieces of information for tariff cost calculation {pieces of information related to the above-mentioned tariffs and agreements} are input and stored in addition to first pieces of information required for conventional (calculating method considering transportation costs and inventory holding costs) design for logistics (pieces of information related to demands (markets), product structures, bases, supply sources, supply destinations and distribution (paths and transportation costs); (2) a second processing portion that configures a plurality of logistics routes (including partial routes (paths) among respective bases configuring the logistics routes) which are subject/candidates of calculation by sequentially pursuing bases (nodes) starting from clients/markets (downstream bases) to suppliers (upstream bases) or from suppliers (upstream bases) to clients/markets (downstream bases) based on the first pieces of information; (3) a third processing portion that performs processes of determining and selecting candidate agreements for each of the above logistics routes and paths; (4) a fourth processing portion that performs processes of calculating total costs (total costs with agreement limitations including tariffs) for each of the logistics routes by adding prime costs, by calculating specified values such as rate of countries of origins, by determining whether agreements are applicable to the paths or not and by adding transportation costs and tariff amounts if applicable for each of the paths in the logistics route ranging from upstream bases to downstream bases; and (5) a fifth processing portion that performs processes of outputting pieces of information of logistics routes with which the above total costs become, for example, minimal, to the user through screen display or the like.

The present design for logistics device includes, for example, a data inputting portion that performs processes of inputting data for design for logistics; a memory portion for storing data for design for logistics; a design for logistics portion that performs processes of calculating costs including tariffs for logistics routes among bases of import and export of products using the input data; and a data display portion that performs processes of displaying, on a screen, pieces of information including logistics routes and costs which are results of processes performed by the design for logistics portion. The input data include pieces of information of articles of products; information of bases; information of paths among bases; information for calculating costs including manufacturing costs, transportation costs, inventory holding costs and other required costs but not including tariffs; information related to free-trade agreements which are application candidates; and information for calculating tariffs in accordance with the agreements. The design for logistics portion performs processes of configuring a plurality of logistics routes including paths among bases ranging from upstream bases to the downstream bases; of extracting agreements that can be associated to each of the logistics routes, of adding costs other than the tariffs for each of the logistics routes; and of adding tariff amounts in accordance with agreements for each of the paths based on the input data to thereby calculate total costs including tariffs for each of the logistics routes.

### Effects of the Invention

According to the typical embodiments of the present invention, it is possible to obtain logistics routes that optimize total costs including not only transportation costs and inventory holding costs but also factors of tariffs in performing global design for logistics and cost calculation and to contribute to improvements in corporate profits.

### BRIEF DESCRIPTIONS OF THE DRAWINGS

FIG. 1 is a diagram showing a functional block structure of a design for logistics device that configures a system according to one embodiment of the present invention;

FIG. 2 is a diagram showing a hardware configuration of the design for logistics device according to the present embodiment;

FIG. 3 is a diagram showing a design for logistics process flow of the design for logistics device according to the present embodiment;

FIG. 4 is a diagram showing an example of demand information (D1) in FIG. 1;

FIG. 5 is a diagram showing an example of product structure information (D2) of FIG. 1;

FIG. 6 is a diagram showing an example of base information (D3) of FIG. 1;

FIG. 7 is a diagram showing an example of supply source information (D4) of FIG. 1;

FIG. 8 is a diagram showing an example of distribution information (D5) of FIG. 1;

FIG. 9 is a diagram showing an example of tariff information (D6) of FIG. 1;

FIG. 10 is a diagram showing an example of agreement information (D7) of FIG. 1;

FIG. 11 is a diagram showing an example of agreement member region information (D8) of FIG. 1;

FIG. 12 is a diagram showing an example of an input screen of the design for logistics device according to the present embodiment;

FIGS. 13A to 13C are diagrams showing bases, paths, logistics routes, agreements and tariffs or the like according to the present embodiment;

FIG. 14 is a diagram showing details of an all logistics route combinations creating process (S2) of FIG. 3;

FIG. 15 is a diagram showing an example of route combination information (D11) of FIG. 1;

FIG. 16 is a diagram showing details of an all agreement combinations creating process (S3) of FIG. 3;

FIG. 17 is a diagram showing an example of agreement combination information (D12) of FIG. 1;

FIG. 18 is a diagram showing examples of agreement combinations according to the present embodiment;

FIG. 19 is a diagram showing details of a cost calculating process including agreement application determination (S4) of FIG. 3;

FIG. 20 is a diagram showing an example of prime cost information by agreements (D13) of FIG. 1;

FIG. 21 is a diagram showing an example of cost information (D14) of FIG. 1;

FIG. 22 is a diagram showing an example of an output screen of the design for logistics device according to the present embodiment;

FIG. 23 is a diagram showing an example of a logistics route (cost) determined by the prior art.

### DESCRIPTIONS OF THE PREFERRED EMBODIMENTS

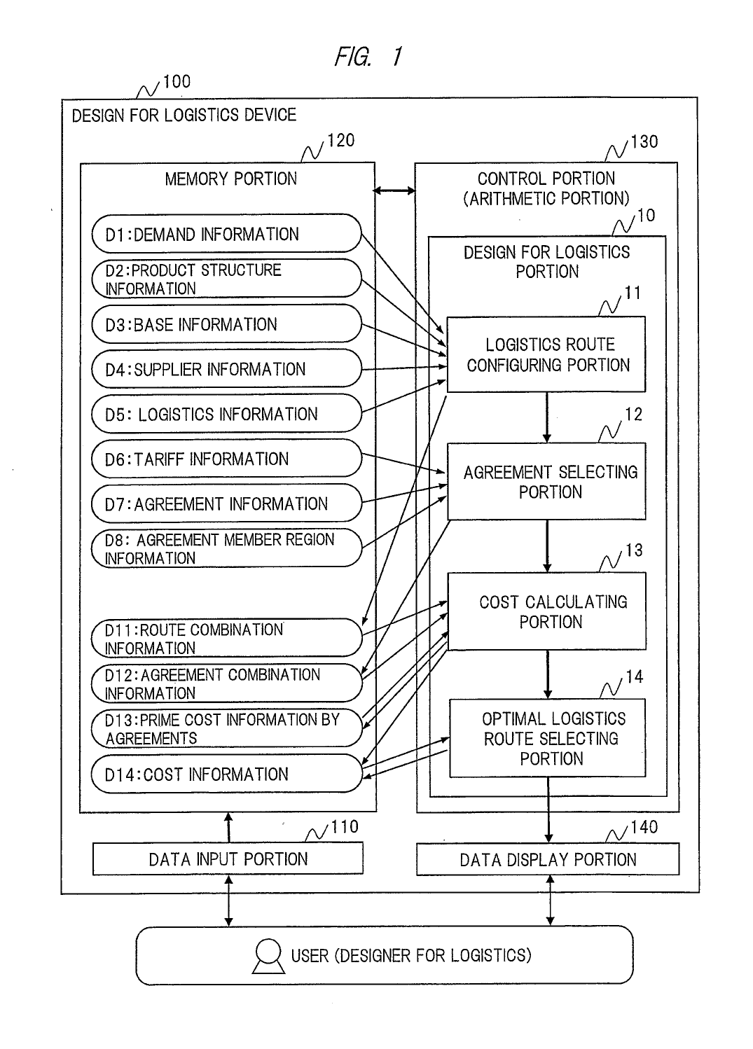

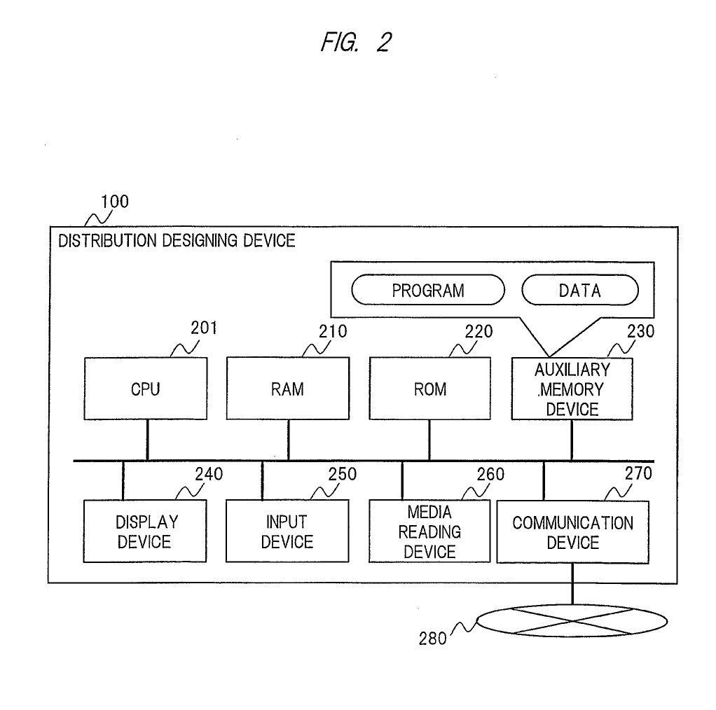

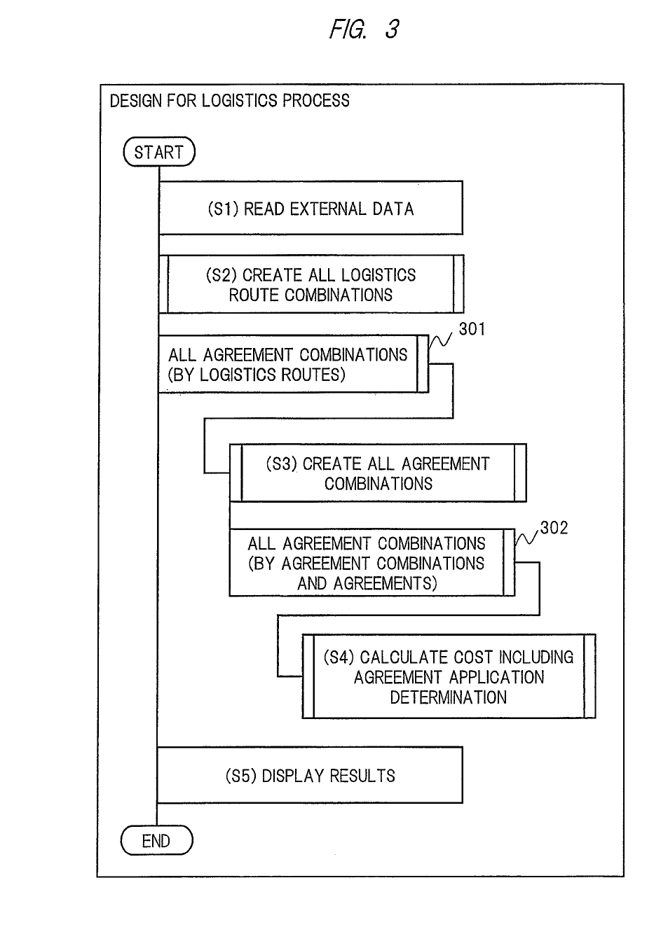

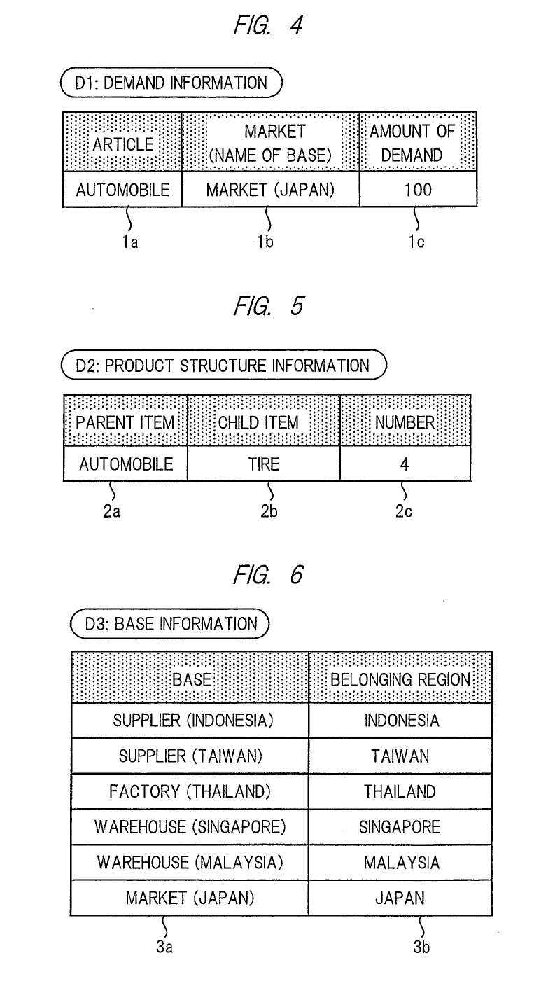

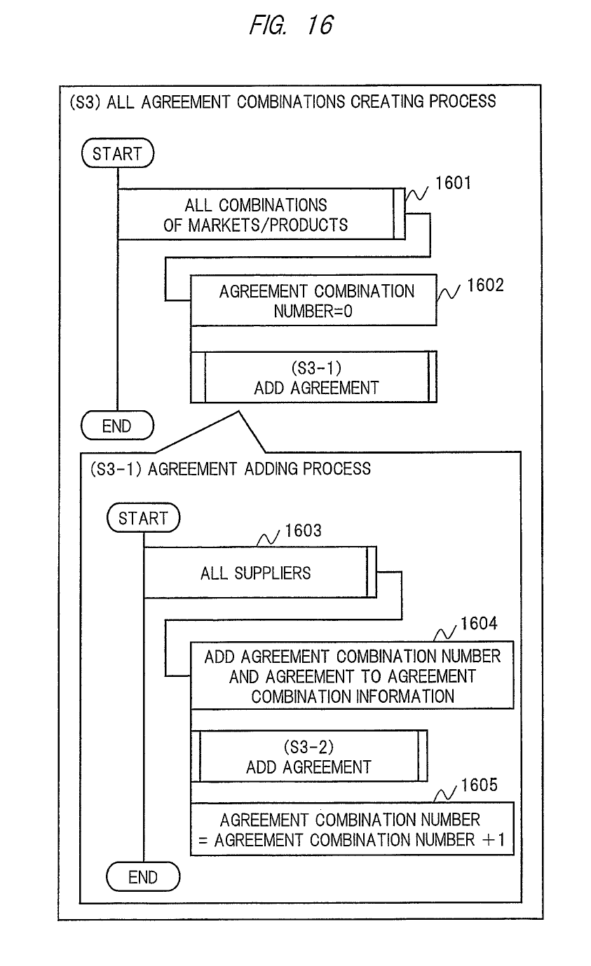

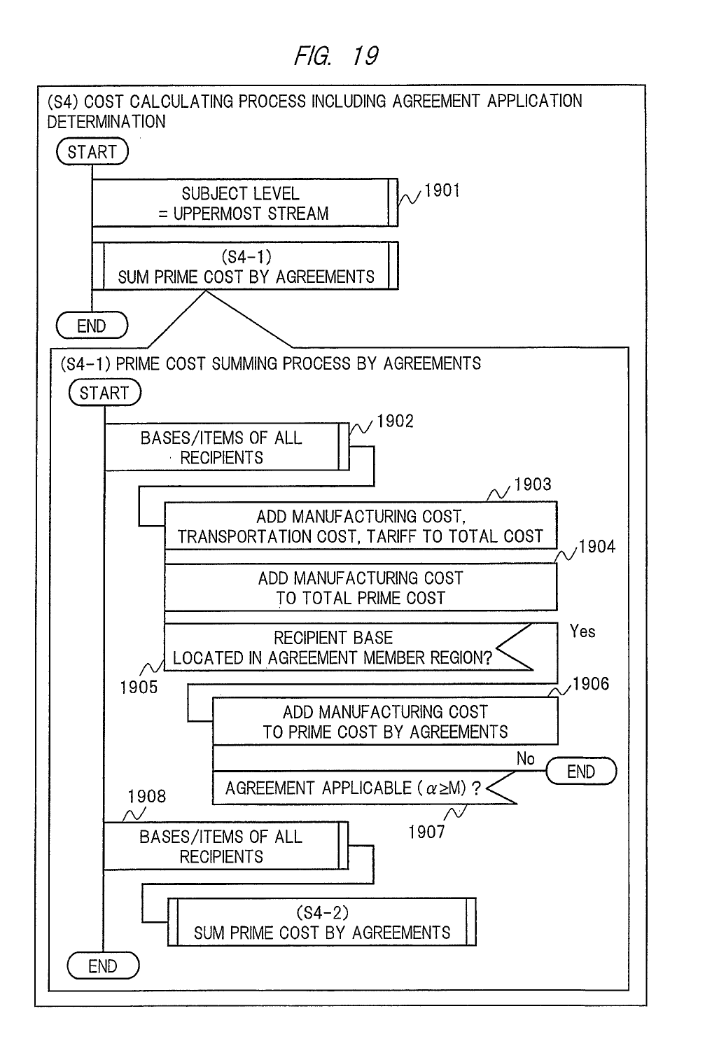

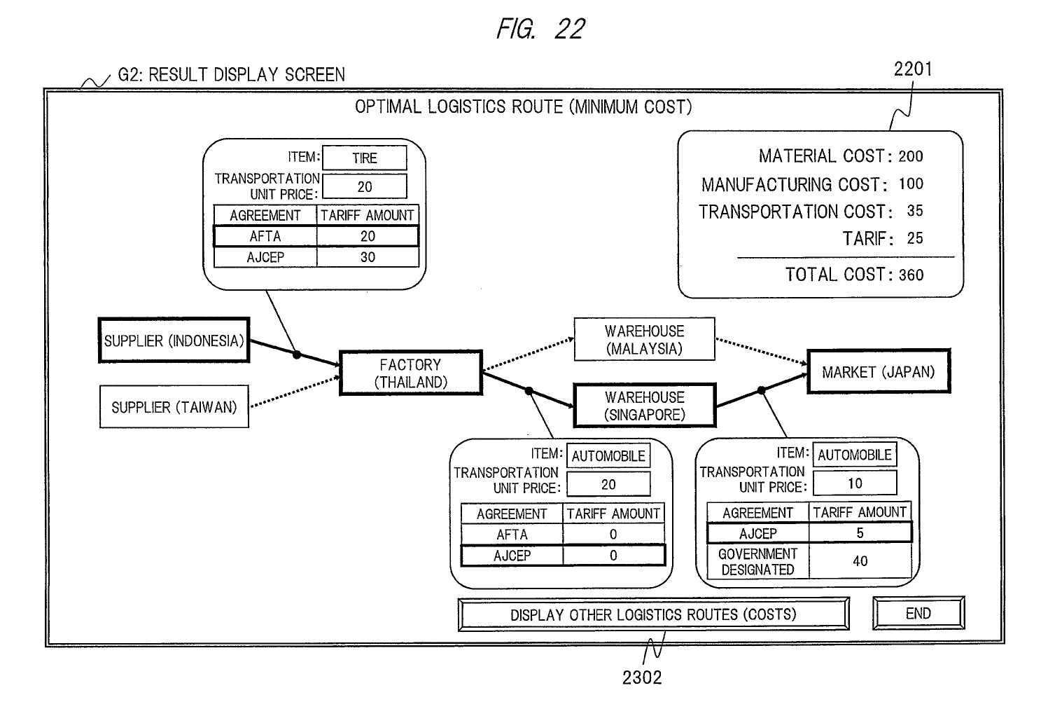

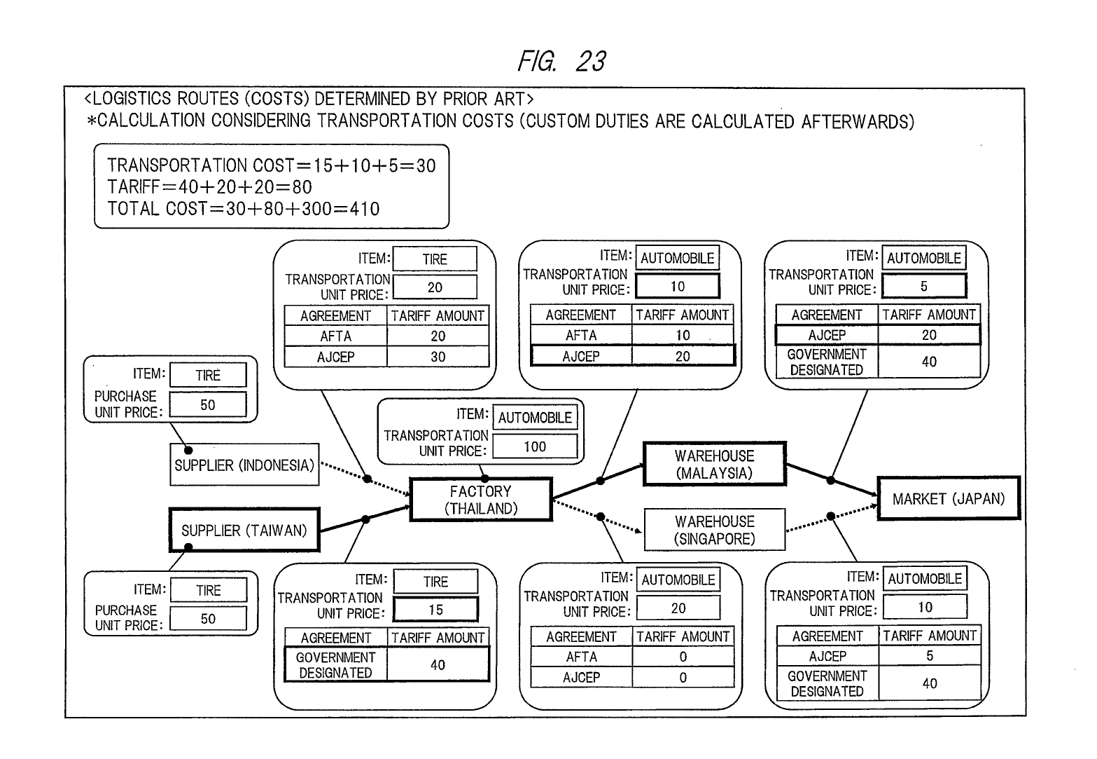

Embodiments of the present invention (such as design for logistics device or design for logistics method) will be explained in details based on the drawings. In this respect, in all of the drawings for explaining embodiments, the same portions are generally marked with the same reference numerals, and repetitive explanations thereof will be omitted. Further, symbols for explanation purposes such as K: base or R: logistics route will be suitably used. A design for logistics device according to the present embodiment performs a design for logistics process of FIG. 3 (details are shown in FIG. 14, FIG. 16, FIG. 19) based on the configuration of FIG. 1, FIG. 2 and others, controls and processes data information of FIGS. 4 to 11, FIG. 15, FIG. 17, FIG. 20, FIG. 21 and others, and enables data input/output operations of an user by using a screen of FIG. 12, FIG. 22 and others. The present design for logistics device comprises a function of calculating and displaying logistics routes with which the total costs including tariffs become minimal (corresponding design for logistics portion 10). Particularly, in the present design for logistics process, logistics routes and paths thereof are configured based on data, agreements which apply to the respective paths are retrieved, the total cost of the respective logistics routes are calculated by summing up cost values related to prime costs, transportation costs and tariffs (tariffs in accordance with applicable agreements) for each of the routes and agreements while performing determinations whether routes are within/without agreement ranges (whether the countries or regions are members of the agreements) and determinations whether agreements are applicable or not for bases ranging from upstream to downstream. Logistics routes with which the total costs become minimal and pieces of information related to corresponding agreements and costs or the like are indicated to the user.

[System Configuration]

A functional block structure of the design for logistics device 100 configuring the system of the present embodiment is shown in FIG. 1. The design for logistics device 100 includes a data input portion 110, a memory portion 120, a control portion (arithmetic portion) 130, and a data display portion 140. The control portion (arithmetic portion) 130 is a portion that performs software program processing using data information of the memory portion 120, and comprises a design for logistics portion 10 as a processing function. The design for logistics portion 10 performs design for logistics processes including processing functions of retrieving and determining optimal logistics routes with which the total costs become minimal while using data information D1 to D8 and others of the memory portion 120. The design for logistics portion 10 includes a logistics route configuring portion 11, an agreement selecting portion 12, a cost calculating portion 13 and an optimal logistics route selecting portion 14.

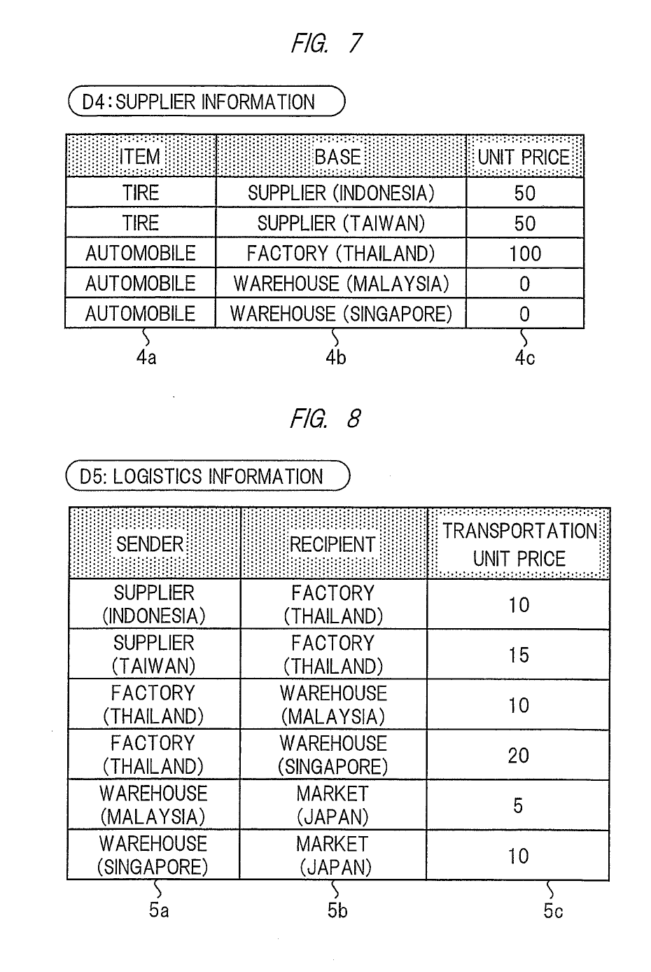

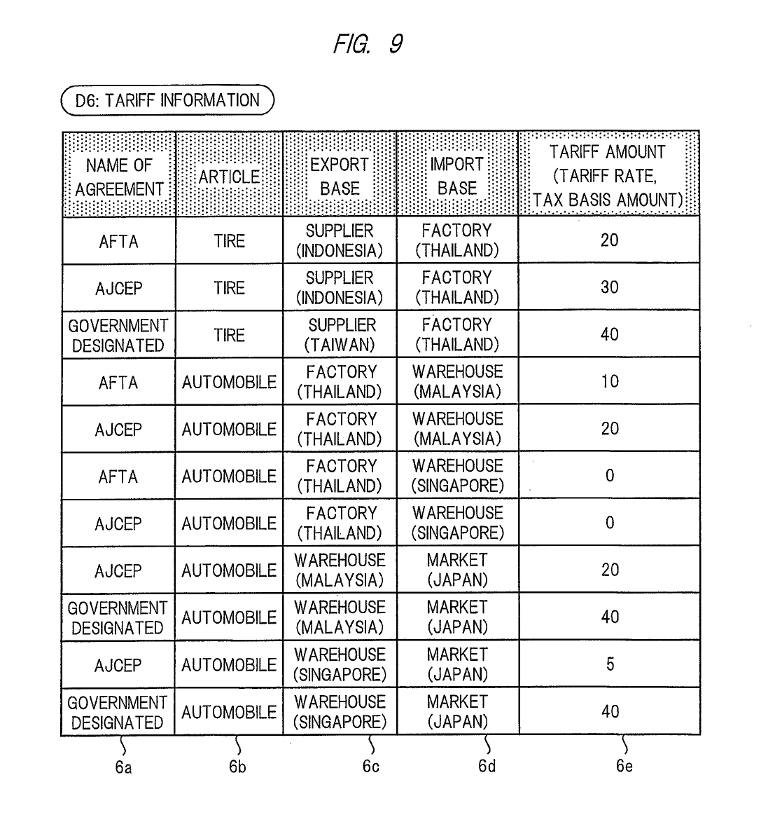

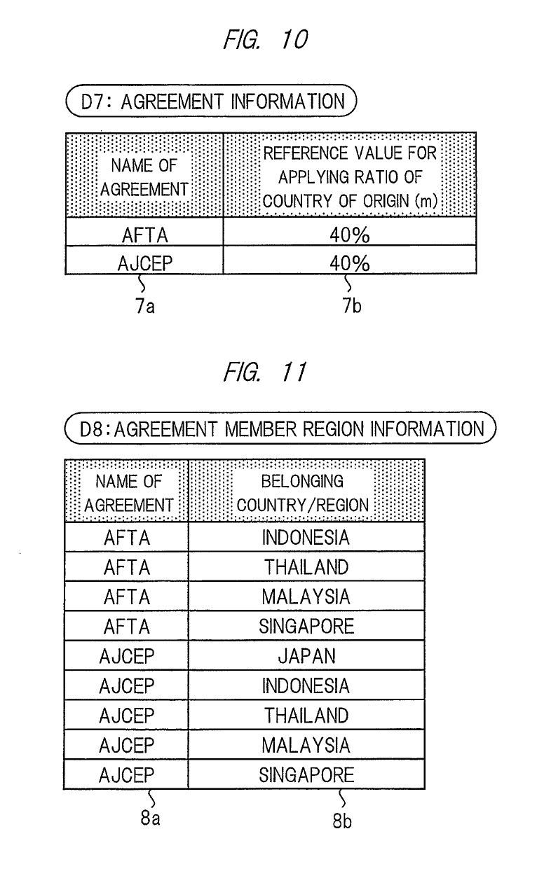

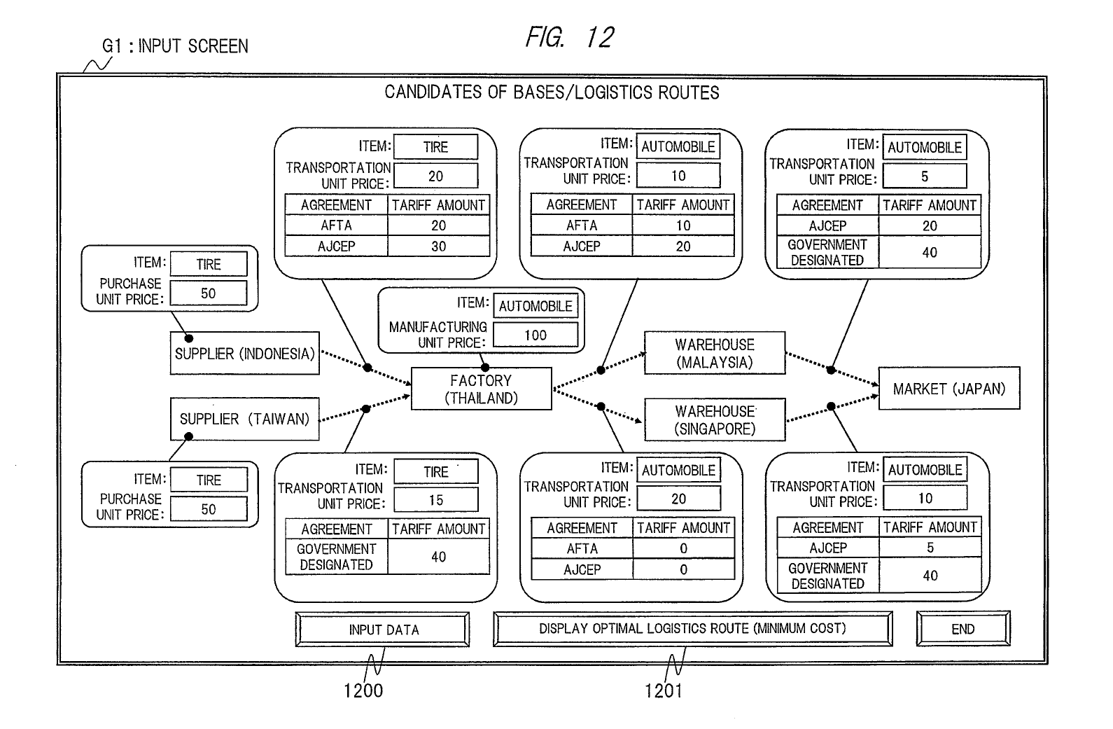

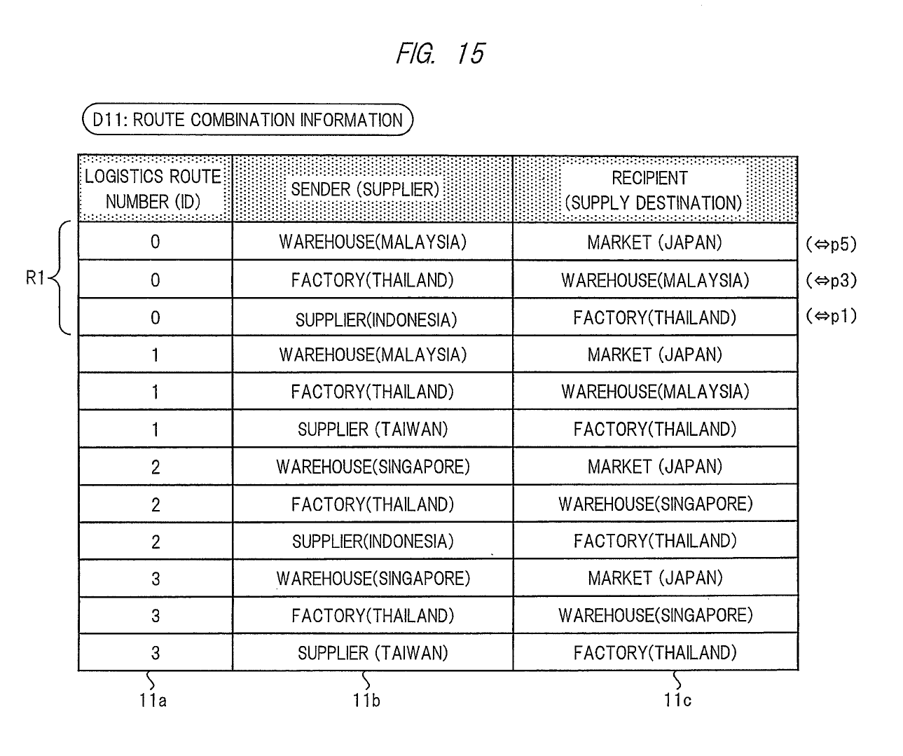

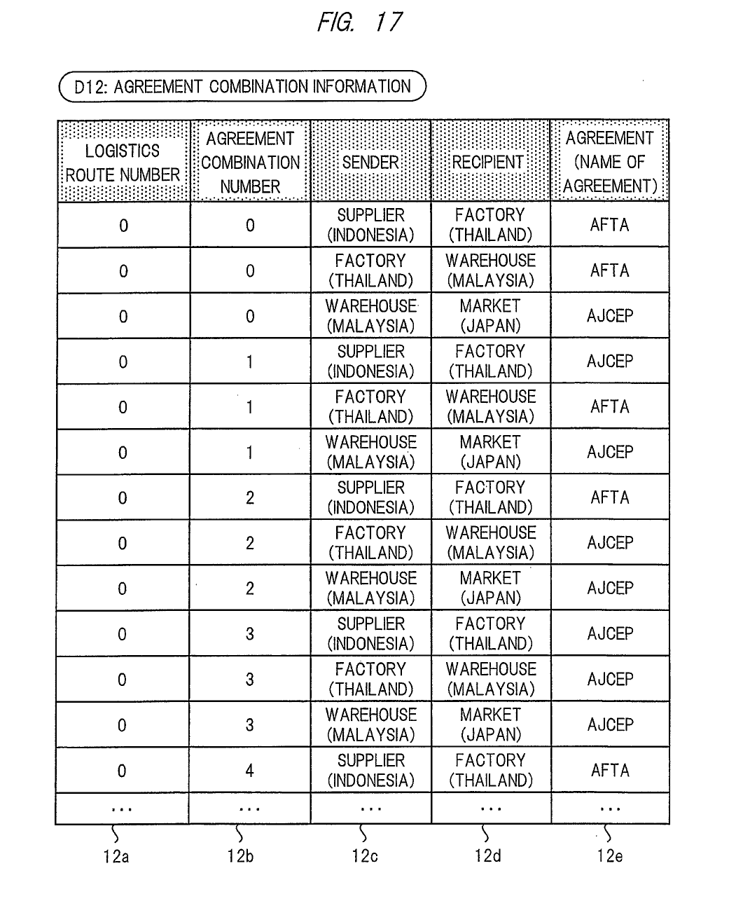

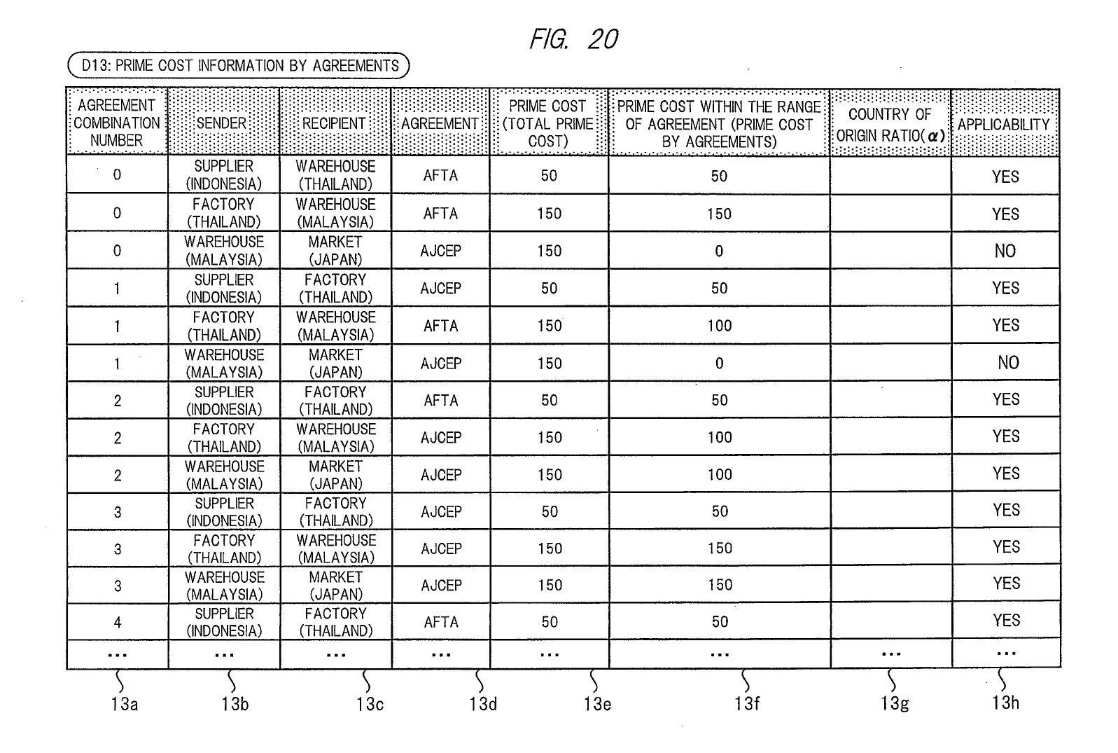

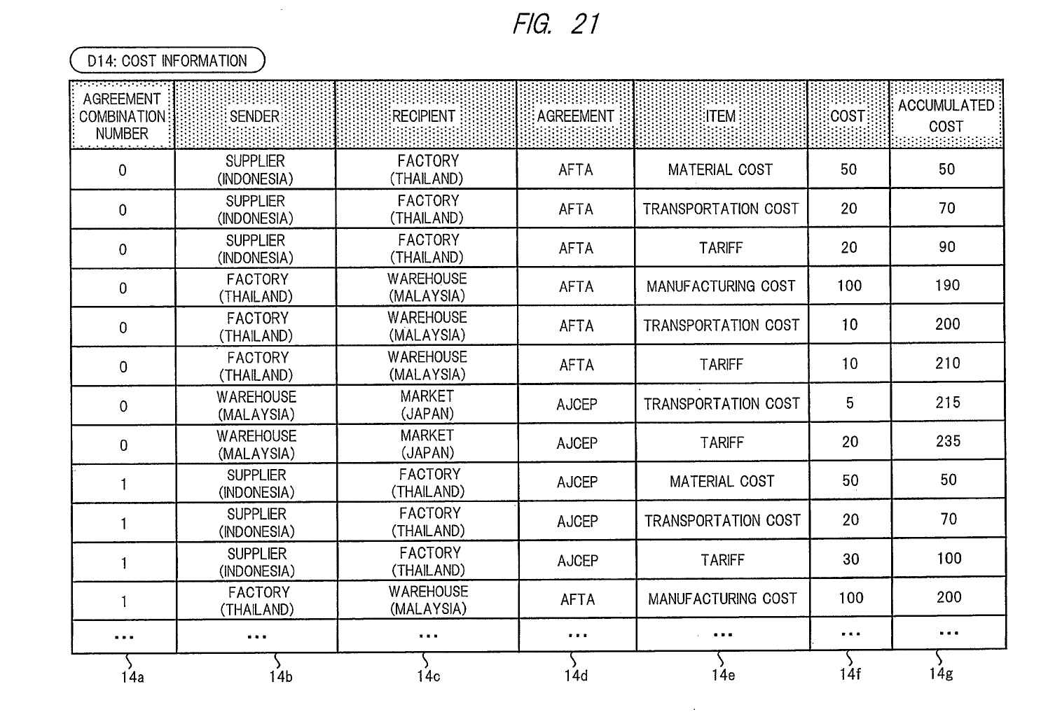

The memory portion 120 stores therein, for example, pieces of data information such as demand information D1 (e.g. FIG. 4), product structure information D2 (e.g. FIG. 5), base information D3 (e.g. FIG. 6), supply source information D4 (e.g. FIG. 7), distribution information D5 (e.g. FIG. 8), tariff information D6 (e.g. FIG. 9), agreement information D7 (e.g. FIG. 10), and agreement member region information D8 (e.g. FIG. 11). The memory portion 120 further stores therein, for example, various pieces of data information calculated in the control portion 130 such as route combination information D11 (e.g. FIG. 15), agreement combination information D12 (e.g. FIG. 17), prime cost information by agreements D13 (e.g. FIG. 20) and cost information D14 (e.g. FIG. 21).

The data input portion 110 performs processes of reading data information such as D1 to D1 and of storing them in the memory portion 120. For example, the data input portion 110 inputs (acquires) D1 to D8 which are external data (for example, data already created in other existing systems) through a network based on operations of a user (distribution designer) and stores them in the memory portion 120. The data input portion 110 further performs processes of directly inputting (setting) data such as D1 to D8 by an user or processes of confirming and updating upon displaying contents by means of a display screen (to be discussed later, FIG. 12) of the design for logistics device 100.

The data display portion 140 performs processes of displaying process result data (for example, those including information regarding optimal logistics routes with which the total costs becomes minimal) of the control portion 130 (design for logistics portion 10) on a screen (to be discussed later, FIG. 12) based on operations of a user (distribution designer). The data display portion 140 may also perform processes such as printing and outputting the data or sending the data to other systems via the network.

The data input portion 110 and the data display portion 140 perform processes of displaying screens (various data such as D1 and other GUI images or the like) for various operations related to distribution design in accordance with instructions of other functional portions (control portion 130) as a user interface. Display is performed, for example, in a web-page style. For example, a screen for data input (to be described later, FIG. 12) is displayed by the data input portion 110 or a screen for process result data output (to be described later, FIG. 22) is displayed by the data display portion 140.

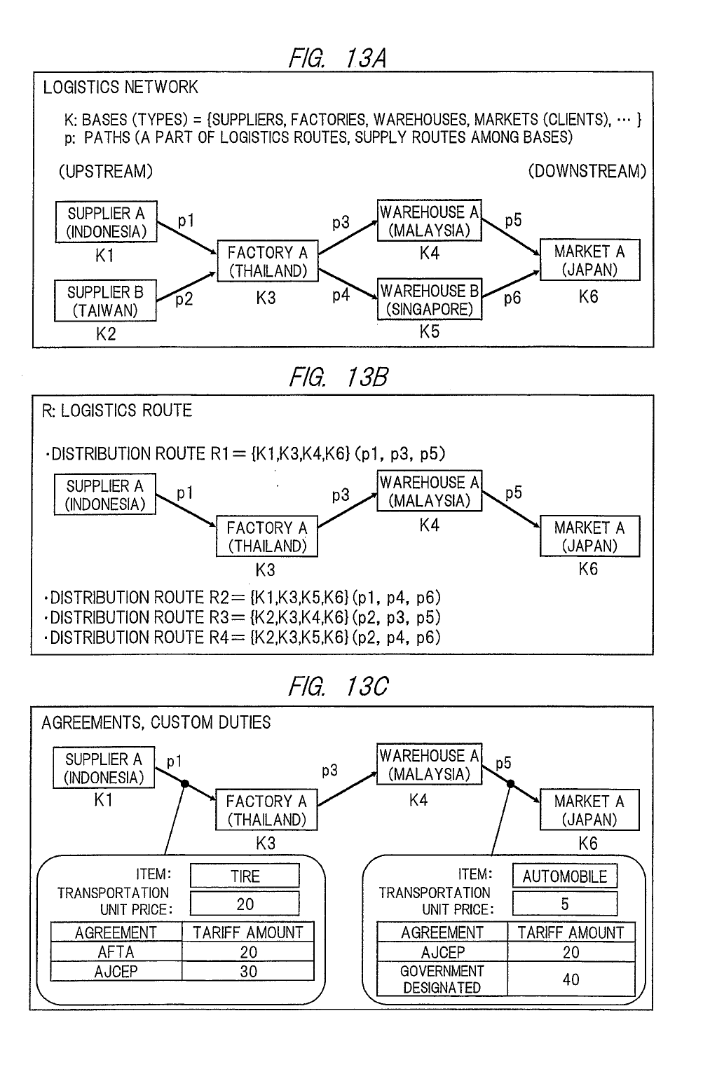

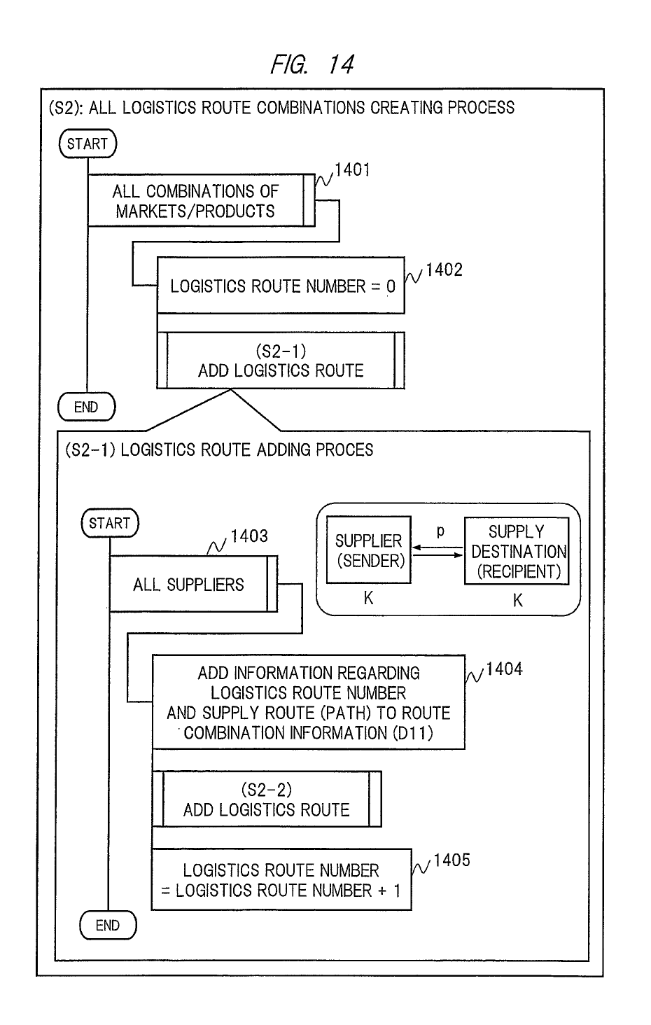

The logistics route configuring portion 11 performs processes of configuring logistics routes and others (e.g. FIG. 13A) which will be a subject/candidate of calculation based on input data. The agreement selecting portion 12 performs processes of selecting agreements and others (e.g. FIG. 13C) which will be a subject/candidate of application by logistics routes (and their paths). The cost calculating portion 13 performs processes of calculating costs including transportation costs and tariffs by logistics routes (and their paths). The optimal logistics route selecting portion 14 performs processes of selecting optimal logistics routes for minimizing total costs including restrictions by agreements based on results obtained by portions up to the cost calculating portions 13.

It is also possible to use other data information to be controlled by the memory portion 120 in accordance with contents of calculation, production information (information including lead times of bases at which respective articles are supplied/manufactured), route information (information related to already configured logistics routes and paths), transportation information (information including transportation lead times), manufacturing cost information, transportation cost information and inventory holding cost information. It is also possible to control information by suitably dividing or combining respective pieces of data information such as D1.

[Design for Logistics Device]

A hardware configuration example of the design for logistics device 100 is shown in FIG. 2. The design for logistics 100 includes, a CPU 201, a RAM 210, a ROM 220, an auxiliary memory device 230, a display device 240, an input device 250, a media reading device 260 and a communication device 270, etc., and can be achieved by, for example, a general PC. For example, the auxiliary memory device 230 stores therein programs and data of the present embodiment. The programs of the present embodiment are application programs that are executable on OS programs that are, for example, read from a portable memory device and installed to the auxiliary memory device 230 via the media reading device 260. The data stored in the auxiliary memory device 230 include respective data stored in the memory portion 120 of FIG. 1.

The CPU 201 executes various processes (including processes of the design for logistics portion 10 of FIG. 1) by executing, for example, specified programs that are loaded from the auxiliary memory device 230 to the RAM 210. The RAM 210 stores therein programs that are executed by the CPU 201 and data required for executing the programs. The ROM 220 stores therein, a program required for starting up the design for logistics device 100 etc. The auxiliary memory device 230 is, for example, an HDD or an SSD. The display device 240 is a display such as a CRT or an LCD. The input device 250 is, for example, a keyboard, a mouse or a microphone. The media reading device 260 is a device for reading information of portable memory media such as CD-ROMs. The communication device 270 is a communication interface for performing data input and output processes with external devices via a network 280.

The data input portion 110 and the data display portion 140 of FIG. 1 can be realized by devices such as the input device 250, the display device 240 and the communication device 270 of FIG. 2 and their control processes. The memory portion 120 of FIG. 1 can be realized by a memory device such as the auxiliary memory device 230 of FIG. 2 and its control processes. The control portion 130 of FIG. 1 can be realized by the CPU 201 of FIG. 2 and others.

[Design for Logistics Process]

A design for logistics process flow (wherein S indicate process steps) of the control portion 130 (design for logistics portion 10) of the design for logistics device 100 is shown in FIG. 3. In the present design for logistics process, performed processes are (S1) an external data reading process, (S2) an all-logistics-route combinations creating process, (S3) an all-agreement combinations creating process to all of the logistics route combinations (301), (S4) a cost calculating process including agreement application determination for all of the agreement combinations (302), and (S5) a result displaying process. S1 is a process mainly performed by the data input portion 110, S2 is mainly performed by the logistics route configuring portion 11, S3 is mainly performed by the agreement selecting portion 12, S4 is mainly performed by the cost calculating portion 13, and S5 is mainly performed by the data display portion 140. Hereafter, respective processes (S1 to S5) will be explained with referring to FIG. 4 and following drawings.

In this respect, 301 indicates that calculation is performed for each of the individual logistics routes R in the combination of logistics routes R (a plurality of logistics routes R) created in S2. 302 indicates that that calculation is performed for each of the individual agreements in the combination of agreements (a plurality of agreements) created in S3.

The calculating method is such that, for example, products/bases included in the demand information D1 (downstream base) are used as starting points of calculation or that products/bases included in the supply source information D4 (upstream base) are used as starting points of calculation to trace along logistics routes/paths up to supply sources (senders) or supply destinations (recipients). Either of the above-mentioned directions will do. The calculating method can be realized by using a known recursive computing algorithm and others.

Further, in the processes of, for example, performing agreement retrieval (selection) and determination of application/non-application (S3, S4), agreements which bases (corresponding countries/regions) of supply destinations (recipients) are members of are automatically selected while referring to the agreement member region information D8 so as to create a combination of respective agreements on the logistics routes. While tracing routes (paths) between upstream and downstream bases for the logistics routes and agreement combinations thereof, prime costs are calculated while adding manufacturing costs involved at the supply destination, and application/non-application of agreements are determined upon comparing a rate of countries of origin (a) and a minimum value (m) for application in accordance with agreement information D7. The total cost is then calculated by adding tariffs in accordance with the applicable agreements.

[(S1) External Data Reading Process]

First, in the external data reading process (S1), data information such as D1 to D8 which are external data are taken in from the network 280 or the like by means of the data input portion 110 and are stored in the memory portion 120 based on accepted user operation. Alternatively, data are input by a user using the input screen (FIG. 12).

[D1: Demand Information]

FIG. 4 is an example (table) of demand information D1. The demand information D1 includes respective data entries for defining an article 1a, a market (name of base) 1b and a demand quantity 1c. 1a is an article name or ID (identification information) of a product or a part. In this respect, a “name” might also be regarded as an ID or a number. The demand information D1 includes a demand quantity when the base is a “market”. The demand information D1 may also be information including sales plans of products.

[D2: Product Structure Information]

FIG. 5 is an example of product structure information D2. The product structure information D2 includes, as data entries, a parent item 2a, a child item 2b and a number 2c. 2a indicates a name of a parent item which is a product to be generated. 2b is a name of a child item which forms a base for creating the parent item 2a. 2c is the number (constituting number) of child items 2b required for generating a single unit of the parent item 2a.

[D3: Base Information]

FIG. 6 is an example of base information D3. Base information D3 includes, as data entries, a base 3a and a belonging region 3b. 3a is a name of a base {supplier, factory, warehouse, market (client) and others}. 3b is a name of a region the base 3a belongs to. The base information D3 includes information related to functions (types) of bases.

[D4: Supply Source Information]

FIG. 7 is an example of supply source information D4. The supply source information D4 includes, as data entries, an article 4a, a base 4b, and a unit cost 4c. 4a is a name of an article that is supplied from a base (4b) of the supply source. 4b is a name of the base of the supply source. 4c is a unit cost (cost) for purchasing, manufacturing or storing one unit of the article at the base 4b.

[D5: Distribution Information]

FIG. 8 is an example of distribution information D5. The distribution information D5 includes, as data entries, a sender 5a, a recipient 5b and a transportation unit cost 5c. 5a is a name of a base which will be the sender (supply source). 5b is a name of a base which will be the recipient (supply destination). 5c indicates a transportation unit cost necessary for transporting one unit of the article in a supply route portion (path p) from the base of the sender 5a to the base of the recipient 5b. The distribution information D5 includes, as its content, transportation master information (information related to transportation cost calculation).

[D6: Custom Duty Information]

FIG. 9 is an example of tariff information D6. The tariff information D6 is information including a tariff amount. The tariff information D6 includes, as data entries, a name of agreement 6a, an article 6b, an export base 6c, an import base 6d, and a tariff amount 6e. 6a is a name of the agreement corresponding to the tariff of interest (agreement corresponding to a definition/rule for calculating the tariff). 6b is a name of an article that is subject of tariff calculation. 6c is a name of a base that exports the item of interest. 6d is a name of a base that imports the article of interest. 6e indicates a tariff amount that occurs when one unit of the article of interest is imported from the export base 6c to the import base 6d in accordance with the agreement of interest 6a. In this respect, 6e may also be rewritten by other pieces of information such as tariff rate and tax basis amount that are imposed when one unit of the same article is imported from the same export base to the same import base.

[D7: Agreement Information]

FIG. 10 is an example of agreement information D7. The agreement information D7 is information including conditions of application for the agreement. The agreement information D7 includes, as data entries, a name of agreement 7a and minimum value for applying the rate of countries of origin 7b. 7a is a name of an agreement of the tariff. 7b indicates a minimum value (threshold) (which is defined as m) of the rate of countries of origin necessary to apply the agreement of interest. For example, when the value (which is defined as a) of the rate of countries of origin calculated in the determining process of S4 for the path p of interest is a value that is not less than the value of 7b (m) (α≧m), the agreement (7a) of interest will be applicable to the path p of interest while it will be not applicable when it is less than the value of 7b (m) (α<m). The above value of m can also be set and changed by a user.

[D8: Agreement Member Region Information]

FIG. 11 is an example of agreement member region information D8. The agreement member region information D8 includes, as data entries, a name of agreement 8a and a belonging country/region 8b. 8a is a name of an agreement related to the tariff. 8b is a name of a country or region that belongs to the agreement.

[Screen (G1)]

Upon completion of input of data D1 (FIGS. 4) to D8 (FIG. 11) in S1, the input data information can be confirmed on a screen (input screen G1) as illustrated in FIG. 12. It is also possible that the user inputs various data using this screen as mentioned above.

In the input screen G1 of FIG. 12, the configuration and information related to the bases K and logistics routes R that will be subjects/candidates are graphically displayed as illustrated. Nodes (frames) of respective bases K are connected by lines (arrows) of paths p (links) and displayed. There are further displayed, for example, pieces of information related to articles or purchase unit costs/manufacturing unit costs (unit costs in accordance with bases) as related information/detailed information of the bases K of interest by using, for example, a style in which frames of respective bases K are connected by lines or the like. Also, pieces of information related to articles, transportation unit costs and candidate agreements and corresponding tariff amounts are displayed as related information/detailed information of the path p of interest by using, for example, a style in which paths p among respective bases K are connected by lines or the like. It is also possible to make information be displayed by selecting or clicking portions of the bases K and paths p. In addition, buttons and menus that are in accordance with operating commands are displayed. It is possible to individually display contents of respective data (D1 etc.) and to perform input and updates using, for example, a button in 1200. It is further possible to calculate the optimal logistics routes (minimal cost) and make it be displayed on an output screen (to be described later) (FIG. 22) by using a button in 1201.

[Supplement 1]

FIG. 13A shows, as a supplement, bases (referred to as K) and logistics routes (referred to as R) in a distribution network. Types of bases K are suppliers, factories, warehouses and markets (clients). The logistics routes R include routes that are extend from upstream (start point) bases K (for example, suppliers) to downstream (end point) bases K (for example, markets). Route portions between adjoining bases K are defined as paths p. The path p is a term used for explanation and may be suitably expressed as, for example, a supply route, a transportation route or a link. FIG. 13A includes K1 to K6 and p1 to p6 illustrated as an example. This is particularly a case in which two types of suppliers and two types of warehouses are provided.

FIG. 13B shows a plurality of logistics routes R (combination) when the bases K of FIG. 13A are included. For example, R1 is a route connecting bases K1, K3, K4 and K6 (a route including paths p1, p3 and p5). In the same manner, it includes the illustrated R2, R3 and R4.

FIG. 13C shows, for example, agreements and tariffs that are subject (candidate) of application to paths p1 and p5 in the logistics route R1 of FIG. 13B. For example, at p1, the article to be transported (product or part) is a tire, the transportation unit cost is 20, and agreements which are subject (candidate) of application are “AFTA” and “AJCEP” and the tariff amounts corresponding to the respective agreements are 20 and 30.

[(S2) All-Logistics-Route Combinations Creating Process]

Next, the all logistics route combinations creating process (S2) as shown in the flow of FIG. 14 is executed. In the present process (S2), a logistics route (supply route) adding process of S2-1 is executed for all combinations (1401) of markets/products. Starting with 0, numbers of a plurality (defined as n) of logistics routes R up to n−1 are added. The process of S2 is executed using data (D1 to D5 and others) of the memory portion 120 by means of the design for logistics portion 10 (particularly logistics route configuring portion 11) whereupon results (route combination information D11 and others) are stored in the memory portion 120.

As a detailed process of S2-1, pieces of information including supply sources of bases and articles of interest (logistics route numbers, paths) are added to the route combination information D11 in the logistics route adding process of S2-2. Thereafter, by recursively calling the present process (S2-2) with bases and articles of the supply source being the target, route combination information D11 (e.g. FIG. 15) are output for all supply sources (1403).

[D11: Route Combination Information]

FIG. 15 is an example of route combination information D11. The route combination information D11 includes, as data entries, a logistics route number (ID) 11a, a sender 11b and a recipient 11c. 11a is a number (ID) for uniquely identifying a logistics route (e.g. 0 to 3). 11b is a name of a base of the sender (supply source). 11c is a name of a base of the recipient (supply destination). All pieces of information of paths p among bases K of combinations of 11b and 11c are stored by logistics routes R (11a). For example, a first logistics route R1 which logistics route number 11a is “0” is composed of paths of three lines as illustrated (corresponding to p1, p3 and p5 of FIG. 13). It is also possible to provide separate data entries such as path numbers.

[(S3) All-agreement Combinations Creating Process]

Then, an all-agreement combinations creating process (S3) is executed for all logistics route combinations as shown in the flow of FIG. 16. In the process of S3, an agreement adding process of S3-1 is performed for all combinations of markets/products. The process of S3 is executed using data (D6 to D8 and others) of the memory portion 120 by means of the design for logistics portion 10 (particularly the agreement selecting portion by agreements 12), and results (agreement combination information D12 and others) are stored in the memory portion 120.

As a detailed process of S3-1, pieces of information including supply sources of bases/articles of interest (agreement combination number, agreement and others) are added to the agreement combination information D12 (1604). Thereafter, by recursively calling the present process (S3-1) with bases/articles of the supply source being the target, pieces of agreement combination information D12 of FIG. 17 are output.

[D12: Agreement Combination Information]

FIG. 17 is an example of an agreement combination information D12. The agreement combination information D12 includes, as data entries, a logistics route number 12a, an agreement combination number 12b, a sender 12c, a delivery source 12d, and agreement (name of agreement) 12e. 12b is a number (ID) for uniquely identifying an agreement combination (e.g. “0” to “4”). 12c and 12d indicate bases (senders, recipients) configuring the paths p, similar to those of the above descriptions. 12e indicates a name of an agreement that might possibly be applied to the path p (e.g. “AJCEP”, “AFTA”).

The agreement combination indicates a combination of one or more agreements that are associated to one or more paths p in the logistics route R. For example, for R1, there are included candidate agreements that might possibly be applied for each of p1, p3 and p5. One line indicates a piece of agreement information in units of a single path p. One agreement combination is shown by a plurality of lines having the same agreement combination numbers. A plurality of agreement combinations are included in one logistics route.

In the process of specifying an agreement 12e, the belonging region is specified based on the base information D3 of FIG. 6 from the recipient 12d, and the agreement member region information D8 of FIG. 11 is referred to from the belonging region to thereby specify a name of agreement.

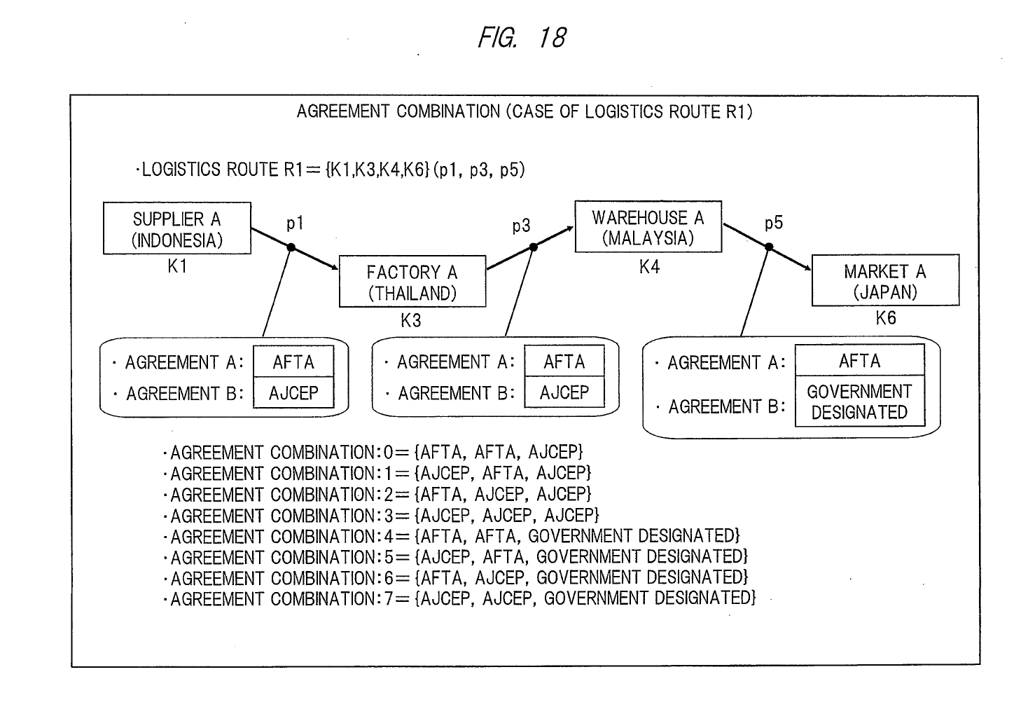

FIG. 18 is an example of an agreement combination corresponding to FIG. 17 (D12) as a supplement. It indicates all agreement combinations (eight) in the case of the logistics route R1. In the path p1, two types of agreements (agreement A: AFTA, agreement B: AJCEP) are possible, while in the path p3, two types of agreements (agreement A: AFTA, agreement B: AJCEP) are possible, and in the path p5, two types of agreements (agreement A: AJCEP, agreement B: government designated) are possible. By combining these (2×2×2), it is possible to obtain eight agreement combinations (numbers: 0 to 7).

[(S4) Cost Calculation Process Including Agreement Application Determination]

Next, a cost calculation process including agreement application determination (S4) as shown in the flow of FIG. 19 is performed. In the present process (S4), a prime cost summing process by agreements of S4-1 is performed for uppermost stream bases/articles (meaning there are no further supply sources) (1901).

The process of S4 is executed by the design for logistics portion 10 (particularly cost calculating portion 13) using data (prime cost information by agreements D13 and others) of the memory portion 120, and results (cost information D14 and others) are stored in the memory portion 120.

As a detailed process of S4-1, the following process is performed for all recipients of the bases/articles of interest. First, [manufacturing cost], [transportation cost] and [tariff] are added to the [full cost (total cost)] (variable) (1903). The [manufacturing cost] is a value that is calculated by [manufacturing unit cost]×[amount of manufacture]. The [transportation cost] is a value that is calculated by [transportation cost]×[amount of transportation]. The [tariff] is a tariff that is defined by the agreement of interest (agreement that is applied in accordance with the path of interest).

Next, only [manufacturing cost] is added to the [total prime cost] (variable) (1904). Thereafter, the belonging region is specified from the base information D3 for a base/article of a recipient, and it is determined whether the belonging region of interest is a member of the subject agreement by referring to the agreement member country information D8.

When the base/article of the above recipient is a member of the subject agreement (Yes), [manufacturing cost] is added to the [prime cost by agreements] (1906) and a determination process (1907) is performed using the following equations (1) and (2). It is determined “agreement applicable” when the following equation (1) is satisfied while it is determined “agreement not applicable” if it is not satisfied.

[rate of countries of origin (α)]≧[reference value for applying agreement (m) ]Equation (1)

[rate of countries of origin (α)]=[prime cost by agreements]/[total prime cost] Equation (2)

When it is determined “agreement not applicable” (No) in the determination of interest, the process is terminated. In the foregoing, the [rate of countries of origin] is defined as a. The above-cited minimum value for applying the rate of countries of origin (m) of the agreement information D7 is used as the [reference value for applying agreement] (threshold for comparison determination). By recursively calling the process of S4-1 for bases/articles of all recipients, it is possible to obtain the prime cost information by agreements D13 of FIG. 20 and the cost information D14 of FIG. 21.

[D13: Prime Cost by Agreements Information]

FIG. 20 is an example of prime cost by agreements information D13. The prime cost by agreements information D13 includes, as data entries, an agreement combination number 13a, a sender 13b, a recipient 13c, an agreement (name of agreement) 13d, a prime cost (total prime cost) 13e, a prime cost within the range of agreement (prime cost by agreements) 13f, a rate of countries of origin (α) 13g, and agreement applicability/non-applicability 13h. 13e corresponds to the above-cited [total prime cost]. 13f corresponds to the above-cited [prime cost by agreements]. 13g corresponds to the rate of countries of origin (a) calculated above, and warehouse thereof is optional (it is stored when it shall be displayed on the screen). 13h is the above-cited value of [agreement applicable]/[agreement not applicable].

[D14: Cost information]

FIG. 21 is an example of cost information D14. The cost information D14 includes, as data entries, an agreement combination number 14a, a sender 14b, a recipient 14c, an agreement (name of agreement) 14d, an item 14e, a cost 14f, and an accumulated cost 14g. 14e indicates a type of cost in accordance with the agreement of interest such as [material cost], [transportation cost], [manufacturing cost] or [tariff]. 14f indicates a cost in accordance with the agreement 14d of interest or the item 14e of interest in units of a path p of interest. 14g indicates a cost obtained by accumulating costs of 14f in units of the path p of interest or the logistics route R of interest. For example, the accumulated cost of the path p1 between the supplier (Indonesia) and factor (Thailand) is an accumulation (addition) of respective cost values of the first three lines of “material cost”, “transportation cost” and “tariff” which will be 50+20+20=90. By further accumulating costs in units of the path, it is possible to obtain the accumulated cost in units of the logistics route R. More particularly, for the logistics route R1 (logistics route number “0” and agreement combination number “0”), the accumulated cost will be 235 as illustrated.

[(S5) Result Displaying Process]

Next, in the result displaying process of S5, a result displaying screen G2 as illustrated in FIG. 22 is displayed (a result is displayed on the screen of the display device 240) upon processes of the data display portion 140 based on user operations. The screen G2 is for only a best logistics route with which the total cost including tariffs being minimal from among the plurality of candidate logistics routes obtained as process results and the corresponding cost information. The user can confirm results on the screen G2 and can also refer to detailed information and others. It is also possible to accept user input for processing from the screen G2 whereupon contents can be changed. Upon completion of display of results as in screen G2, corresponding pieces of information are stored in the memory portion 120.

[Screen (G2)] In the result displaying screen G2, the total cost and a breakdown thereof (material cost, manufacturing cost, transportation cost, tariff, total cost) are displayed using the prime cost information by agreements D13 of FIG. 20 or the cost information D14 of FIG. 14 as inputs (2201). In the present example, the material cost=200, the manufacturing cost=100, the transportation cost=35 and the tariff=25 such that the total cost=360.

It can be understood from the example of FIG. 22 that a contract shall be made with supplier in Indonesia (base K1) and a warehouse shall be set up in Singapore (base K5) for minimizing the total cost. Further, it can be understood that in importing (pl) from the supplier in Indonesia (K1) to the factory in Thailand (K3), AFTA shall be applied as the agreement while in importing (p4) from the factory in Thailand (K3) to the warehouse in Singapore (K5), AJCEP shall be applied as the agreement, and in importing (p6) from the warehouse in Singapore (K5) to the Japanese market (K6), AJCEP shall be applied as the agreement (a minimal cost can be achieved).

Further, it is also to display other logistics routes and cost information that have been already calculated in addition to the above-described best logistics route and cost information. For example, it is possible to display respective logistics routes and cost information in ascending order of total costs in form of a list or the like by using the button of 2202, and the user can arbitrarily select and display some data from among them to perform comparative studies. It is also possible to determine, for example, for a second or lower ranked logistics route.

[Conventional Calculating Method]

FIG. 23 shows, for the sake of comparison, a logistics route and cost determined using the prior art (conventional calculation method) (note that this is not a display screen). There is shown, as a conventional calculating method, a value of a case in which the total cost has been minimized upon considering the transportation cost while the tariff has been calculated afterwards. As illustrated, the logistics route {supplier (Taiwan)—factory (Thailand)—warehouse (Malaysia)—market (Japan)} has been determined while selecting paths of less transportation costs from among candidate paths. While the cost considering the transportation cost is restricted thereby (15+10+5=30), no considerations are made of tariffs. There is shown a value obtained by calculating tariffs in accordance with agreements that are applied to the above selected paths afterwards (40+20+20=80).

By adding the above transportation cost (30) and the tariff (80) to the remaining cost (300), the actual total cost (410) is determined.

When comparing the total cost (410) determined by the prior art and the total cost (360) of the optimal logistics route according to the present embodiment as shown in FIG. 22, the cost of the present embodiment will be lower by 14%. Since cost calculation is performed in a local point of view with regards to transportation cost and others, it might be that the obtained result is not optimal in view of the entire cost. On the other hand, according to the present embodiment, it is possible to optimize (minimize) total costs including tariffs.

[Regarding Rate of Countries of Origin]

In the present embodiment, the [rate of countries of origin] (13g of D13) is used as a value (a) that is a subject of determination in determining application of an agreement/tariff for a logistics route (S4). Agreements, rate of countries of origins and tariffs form specified corresponding relationships. While this value (a) is used corresponding to current international rules (respective agreements), if it should happened that, for example, rules will change in the future and this value (a) will be inappropriate, specified values that are in accordance with actual rules and corresponding thresholds shall be defined (set) and used in a similar manner. For example, upon defining a specified value that is used instead of a as p and threshold values as X, Y, it is determined “applicable” when X>β≧Y is satisfied.

[Regarding Inventory Holding Cost]

While the inventory holding cost, which is a conventional element, is not explained in the present embodiment since it features on the fact of including tariffs into the calculation and for the sake of simplifying explanations, it is possible to similarly and easily realize a function of calculating the total cost including the inventory holding cost by using a calculating method for inventory holding costs (known art).

[Effects and Others]

As described in the foregoing, according to the present embodiment, it is possible to obtain logistics routes capable of optimizing total costs including tariffs in performing global logistics routes and cost calculations. The user can perform design for logistics in an easy understandable manner by using the GUI screen. Decisions and calculations of users related to agreements and tariffs are simplified through automation.

While the invention that has been made by the inventor has been concretely explained based on the embodiment thereof, the present invention is not limited to the above embodiment but it goes without saying that it can be variously modified without departing from the gist thereof. Modifications as follows, for example, can be made.

(1) It is possible to provide a process function of performing, in addition to performing calculation concerning all candidate bases/routes in a distribution network, limited calculation for a part of bases/routes that has, for example, been arbitrarily designated on a screen by a user.

(2) In the above-described embodiment, agreements that are candidates of application to the respective paths are automatically retrieved (selected) (12, S3) and determination of application of the agreements of interest (comparison determination of a and m) in performing cost calculation is made thereafter (13, S4). The present invention is not limited to this, and it is also possible to use an embodiment in which, for example, the above-described process of retrieving (selecting) agreements are omitted but agreements to be applied to the respective paths are defined (set) as to be given whereupon determination of application/non-application of the agreements to paths is similarly performed at the time of cost calculation to perform processes of calculating logistics routes that minimize total costs and combinations of corresponding agreements.

### INDUSTRIAL APPLICABILITY

The present invention is applicable to information processing systems for design for logistics and tariff calculations.

1. A design for logistics device for performing information processing of design for logistics including cost calculation, comprising:
a data input portion that performs processes of inputting data for the design for logistics;
a memory portion that stores data for the design for logistics;
a design for logistics portion that performs processes of calculating costs including tariffs for logistics routes among bases for importing and exporting products using the input data; and
a data display portion that performs processes of displaying pieces of information including logistics routes and costs as results of the processes of the design for logistics portion on a screen,
wherein the input data include pieces of information regarding articles of products, information regarding bases, information regarding paths among bases, information for calculating costs excluding tariffs and including manufacturing costs, transportation costs, inventory holding costs and other necessary costs, information regarding free-trade agreements that are candidates of application and information for calculating tariffs in accordance with the agreements of interest, and
wherein the design for logistics portion performs processes of configuring a plurality of logistics routes including paths among respective bases ranging from upstream bases to downstream bases, of extracting agreements that are associated to each of the logistics routes, of adding costs other than the tariffs for each of the logistics routes, adding tariff amounts in accordance with agreements for each of the paths and of accordingly calculating total costs including tariffs for each of the logistics routes based on the input data.

2. The design for logistics device according to claim 1, wherein the input data include pieces of information regarding articles of products, information regarding bases including suppliers, factories, warehouses and markets as types, information regarding paths among bases, information for calculating costs excluding tariffs and including manufacturing costs, transportation costs, inventory holding costs and other necessary costs, information regarding free-trade agreements that are candidate of application, and information for calculating tariffs in accordance with the agreements of interest, and
wherein the design for logistics portion comprises:
a first processing portion that configures combinations of a plurality of logistics routes including paths among respective bases ranging from upstream bases to downstream bases based on the input data,
a second processing portion that selects agreements that are candidate of application to each of the paths of the logistics routes by determination relevant agreements for the bases or for countries or regions corresponding to the bases and that configures combinations of agreements of the respective logistics routes,
a third processing portion that calculates, for each of the logistics routes and paths, prime costs, that adds costs excluding tariffs, that calculates a rate of countries of origins (a), that determines whether agreements of interest are applicable or not to paths of interest by comparing the rate of countries of origins (a) and reference values (m), and that adds tariff amounts in accordance with agreements of interest where applicable to thereby calculate total costs including tariffs for each of the logistics routes, and
a fourth processing portion that selects logistics routes with which the total costs become minimal, and that outputs pieces of information regarding the logistics routes of interest and corresponding costs, agreements and tariffs.

3. The design for logistics device according to claim 1,
wherein the input data include pieces of information showing relationships of information regarding agreements, articles of products, export bases, import bases, tariff amounts in accordance with agreements or definition information for calculating tariff amounts, information regarding reference values (m) of a rate of countries of origins that are used in determining applicability/non-applicability of agreements to paths, and information regarding belonging countries or regions in accordance with agreements.

4. The design for logistics device according to claim 1,
wherein the data display portion displays pieces of information regarding candidate bases, paths, logistics routes, articles, unit costs, agreements and tariff amounts in association with each other and in a graphical manner on an input screen.

5. The design for logistics device according to claim 1, wherein the data display portion displays pieces of information regarding optimal logistics routes with which the total costs are minimized and corresponding costs, agreements and tariff amounts in association with each other and in a graphical manner on an output screen.

6. The design for logistics device according to claim 1,
wherein the data display portion displays pieces of information regarding a plurality of logistics routes and corresponding costs, and agreements in association with each other and in a graphical manner in the order of the total costs on an output screen.

7. The design for logistics device according to claim 1,
wherein agreements which are candidates of application to respective paths in the logistics routes are defined to be previously set specified agreements, and
wherein the design for logistics portion comprises:
a first processing portion that configures combinations of a plurality of logistics routes including paths among respective bases ranging from upstream bases to downstream bases based on the input data,
a second processing portion that selects candidate agreements that are applied to each of the paths of the logistics routes using the specified agreements and that configures combinations of agreements of the respective logistics routes,
a third processing portion that calculates, for each of the logistics routes and paths, prime costs, that adds costs excluding tariffs, that calculates rate of countries of origins (a), that determines whether agreements of interest are applicable or not to paths of interest by comparing the rate of countries of origins (a) and reference values (m), and that adds tariff amounts in accordance with agreements of interest where applicable to thereby calculate total costs including tariffs for each of the logistics routes, and
a fourth processing portion that selects logistics routes with which the total costs become minimal, and that outputs pieces of information regarding the logistics routes of interest and corresponding costs, agreements and tariffs.

8. A design for logistics method for performing information processing of design for logistics including cost calculation using a computer, comprising:
a first step of performing processes of inputting data for the design for logistics and of storing the same;
a second step of performing processes of calculating costs including tariffs for logistics routes among bases for importing and exporting products using the input data; and
a third step of performing processes of displaying pieces of information including logistics routes and costs as results of processes of the design for logistics portion on a screen,
wherein the input data include pieces of information regarding articles of products, information regarding bases, information regarding paths among bases, information for calculating costs excluding tariffs and including manufacturing costs, transportation costs, inventory holding costs and other necessary costs, information regarding free-trade agreements that are candidates of application, and information for calculating tariffs in accordance with the agreements of interest, and
wherein in the second step, there are performed, based on the input data, processes of configuring a plurality of logistics routes including paths among respective bases ranging from upstream bases to downstream bases, of extracting agreements that are associated to each of the logistics routes, of adding costs other than the tariffs for each of the logistics routes, adding tariff amounts in accordance with agreements for each of the paths and of accordingly calculating total costs including tariffs for each of the logistics routes.

9. A design for logistics program for performing information processing of design for logistics including cost calculation using a computer, comprising:
a first program of performing processes of inputting data for the design for logistics and of storing the same,
a second program of performing processes of calculating costs including tariffs for logistics routes among bases for importing and exporting products using the input data, and
a third program of performing processes of displaying pieces of information including logistics routes and costs as results of processes of the design for logistics portion on a screen,
wherein the input data include pieces of information regarding articles of products, information regarding bases, information regarding paths among bases, information for calculating costs excluding tariffs and including manufacturing costs, transportation costs, inventory holding costs and other necessary costs, information regarding free-trade agreements that are candidate of application and information for calculating tariffs in accordance with the agreements of interest, and
wherein in the processes of the second program perform, based on the input data, processes of configuring a plurality of logistics routes including paths among respective bases ranging from upstream bases to downstream bases, of extracting agreements that are associated to each of the logistics routes, of adding costs other than the tariffs for each of the logistics routes, of adding tariff amounts in accordance with agreements for each of the paths, and of accordingly calculating total costs including tariffs for each of the logistics routes.
